(19) United States
(12) Patent Application Publication
(10) Pub. No.: US 2012/0209919 A1
(43) Pub. Date: Aug. 16, 2012

(54) Social Net Advocacy Contextual Text Analytics

(76) Inventors: Shesha Shah, Bangalore (IN); Rajiv Narang, Austin, TX (US)

(21) Appl. No.: 13/027,738

(22) Filed: Feb. 15, 2011

(51) Int. Cl. G06F 15/16

(52) U.S. Cl. 709/205

(57) ABSTRACT

A method and system are disclosed for monitoring user interactions and generating proactive responses thereto within a social media environment. Social media interactions are monitored, collected, and processed to generate contextual text analyses, which are then processed with social network advocacy data to generate a social network advocacy conversation table. In turn, data associated with the contextual text analyses is likewise processed with social network advocacy data to generate a social network advocacy conversation index, which is used to generate a social network advocacy metric. The resulting metric is used as an indicator of the affect of the user interactions within a target social media environment and the effectiveness of corresponding proactive responses

### CROSS REFERENCE TO RELATED APPLICATIONS

U.S. patent application Ser. No. ______, entitled “Social Net Advocacy Process and Architecture” by inventors Shesha Shah and Rajiv Narang, Attorney Docket No. DC-18676, filed on even date herewith, describes exemplary methods and systems and is incorporated by reference in its entirety.

U.S. patent application Ser. No. ______, entitled “Social Net Advocacy Business Applications” by inventors Shesha Shah and Rajiv Narang, Attorney Docket No. DC-18691, filed on even date herewith, describes exemplary methods and systems and is incorporated by reference in its entirety.

U.S. patent application Ser. No. ______, entitled “Social Net Advocacy Measure” by inventors Shesha Shah and Rajiv Narang, Attorney Docket No. DC-18692, filed on even date herewith, describes exemplary methods and systems and is incorporated by reference in its entirety.

### BACKGROUND OF THE INVENTION

1. Field of the Invention

Embodiments of the invention relate generally to information handling systems. More specifically, embodiments of the invention provide a method and system for monitoring user interactions and generating proactive responses thereto within a social media environment.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

These same information handling systems have been just as instrumental in the rapid adoption of social media into the mainstream of everyday life. Social media commonly refers to the use of web-based technologies for the creation and exchange of user-generated content for social interaction. As such, it currently accounts for approximately 22% of all time spent on the Internet. More recently, various aspects of social media have become an increasingly popular for enabling customer feedback, and by extension, they have likewise evolved into a viable marketing channel for vendors. This new marketing channel, sometimes referred to as “social marketing,” has proven to not only have a higher customer retention rate than traditional marketing channels, but to also provide higher demand generation “lift” across a channel

Traditional methods of measuring the effectiveness of a social media channel include Social Media Analytics (SMA), determining a Net Promoter Score (NPS), and likewise determining a Brand Health Score (BHS). NPS is a customer loyalty metric intended to reduce the complexity of implementation and analysis frequently associated with measures of customer satisfaction with the objective of creating more “Promoters” and fewer “Detractors.” As such, a Net Promoter Score is intended to provide a stable measure of business performance that can be compared across business units and even across industries while increasing interpretability of changes in customer satisfaction trends over time. Currently, several approaches are known for defining, calculating and monitoring a Brand Health Score. In general, these approaches typically include the generation of a score card that comprises a mix of leading and lagging indicators of the health of a brand, whether individually, or as part or a brand portfolio.

Such scores assist executives in understanding the return on investment (ROI) of their marketing investments, and by extension, the value of long-term versus short-term investments. However, neither of these approaches provide social media channel feedback in real-time. As a result, marketers are unable to proactively react to changes in consumer sentiment, which can adversely affect revenue and profits.

### SUMMARY OF THE INVENTION

A method and system are disclosed for monitoring user interactions and generating proactive responses thereto within a social media environment. In various embodiments, a social network advocacy (SNA) system is implemented to monitor one or more social media environments for user interactions that are related to a target subject, such as vendor's product. In these and other embodiments, the social media interactions are collected and then processed to generate social media contextual text analyses. In turn, the media contextual text analyses are used by the SNA system to generate an SNA metric quantifying the affect of the user interactions.

In various embodiments, SNA data (i.e., user generated social network advocacy content or conversations) is processed by a social media content miner system in conjunction with a sentiment miner system to provide input to a linguistic and statistical analysis system for the generation of contextual text analyses. In these and other embodiments, tokenizer operations are first performed on the SNA data, followed by subject term spotting operations being performed on resulting output. In turn, subject term disambiguation operations are performed to generate disambiguated terms, which are then parsed, tagged and processed by a sentiment analyzer to analyze the disambiguated terms for their associated sentiment data values. The resulting sentiment value data is in turn processed to generate contextual text analyses.

In various embodiments, an SNA conversation table is generated, which comprises a user ID, and a plurality of conversation segments, external social media behavior data, online behavior data, registered user data, and other associated SNA data. In these and other embodiments, segment data is generated, which in turn is processed with data contained in an SNA conversation table to generate an SNA conversation index that is dynamically updated as its corresponding conversation grows in size or changes in its composition. In various embodiments, the SNA conversation index is then used to generate an SNA metric, which is used as an indicator of the affect of the user interactions within a target social media environment and the effectiveness of corresponding proactive responses. This metric integrates various data sources with user generated content and is real-time and dynamic. The SNA system addresses issues of opinion and shelf life, to provide SNA data that is relevant and actionable.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of the components of an information handling system as implemented in the system and method of the present invention;

FIG. 2 is a simplified block diagram showing an implementation of a social network advocacy (SNA) system;

FIG. 3 is a simplified block diagram showing a social media customer relationship management (CRM) analytical cycle;

FIG. 4 is a simplified block diagram showing the affect on social media feedback channels as a result of implementing an SNA system;

FIG. 5 is a simplified block diagram of the architecture of an SNA system;

FIG. 6 is a simplified block diagram showing the aggregation and processing of social network advocacy (SNA) data to generate social media conversation analysis data;

FIG. 7 is a generalized flow chart of the operation of an SNA system;

FIG. 8 is a generalized depiction of the affect of an implementation of an SNA system on market capitalization value;

FIG. 9 is a simplified block diagram showing the use of a plurality of social media conversation parameters to dynamically generate an SNA metric;

FIG. 10 is a simplified block diagram showing the generation of an SNA metric;

FIG. 11 is a simplified block diagram showing the operation of a sentiment miner system to generate social media contextual text analyses;

FIG. 12 is a generalized depiction of an SNA conversation segmentation table; and

FIG. 13 is a generalized depiction of an SNA conversation index table.

### DETAILED DESCRIPTION

A method and system is disclosed for monitoring user interactions and generating proactive responses thereto within a social media environment. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

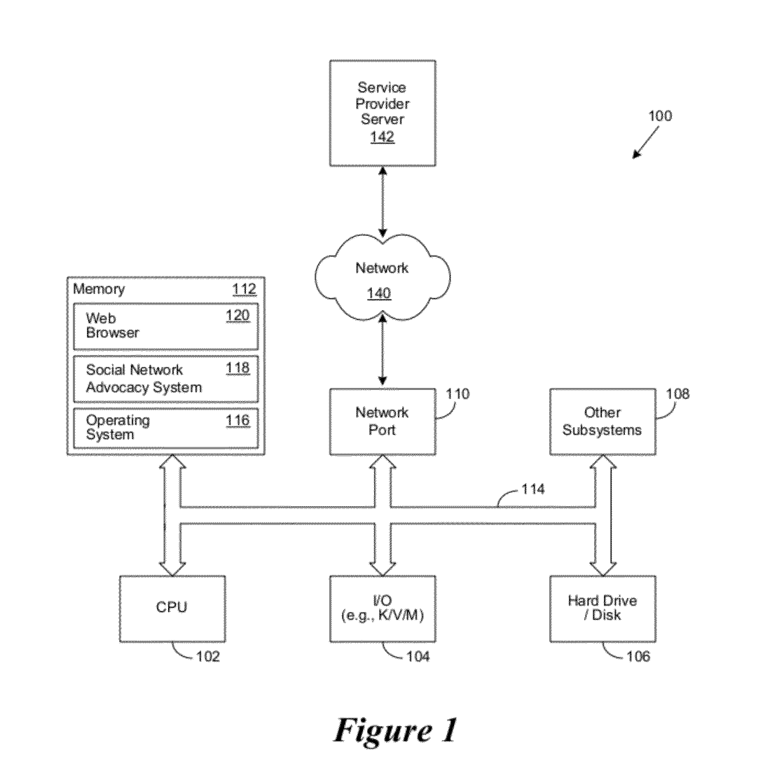

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and a Web browser 126. In various embodiments, the system memory 112 may also comprise a social network advocacy system 118. In one embodiment, the information handling system 100 is able to download the Web browser 126 and the social network advocacy system 118 from the service provider server 142. In another embodiment, the social network advocacy system is provided as a service from the service provider server 142.

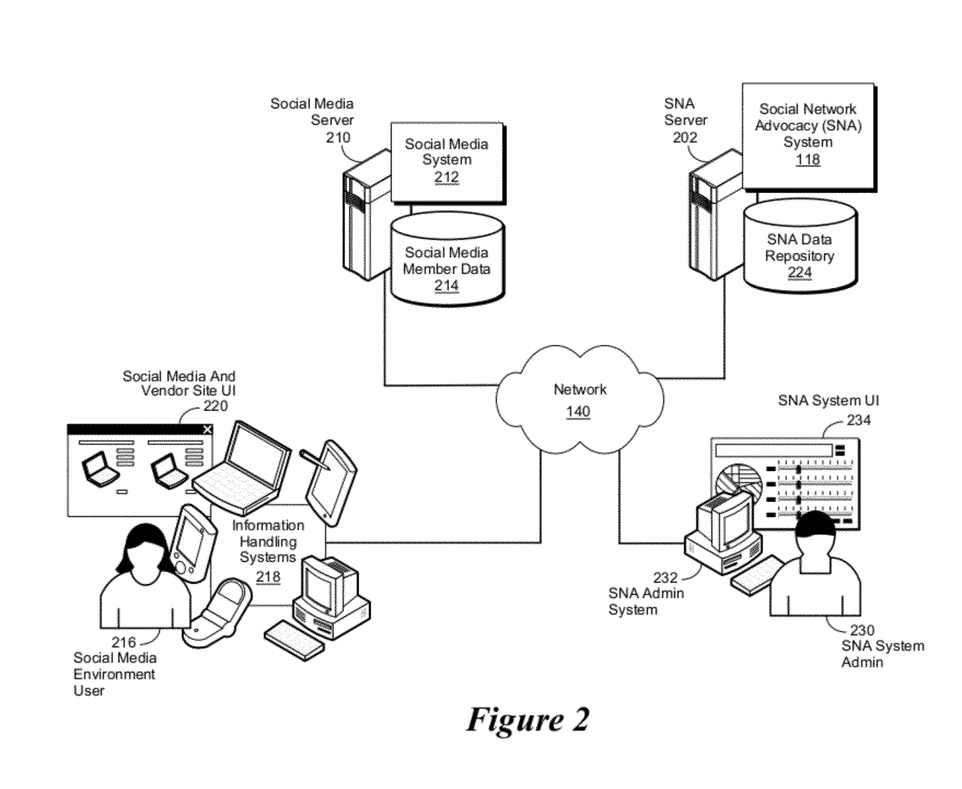

FIG. 2 is a simplified block diagram showing an implementation of a social network advocacy (SNA) system in accordance with an embodiment of the invention. As used herein, social net advocacy (SNA) refers to a metric that provides a measure of the affect on the health of a business as a result of user interactions conducted within a social media environment. More specifically, it measures the net influence resulting from the user interactions generated by ravers, who generate positive interactions, and ranters, who generate negative interactions, within one or more social media environment. As such, it provides a correlation to a vendor's, or a vendor's product's, Net Promoter Score (NPS) and Brand Health scores on a near-real-time basis and provides a single, actionable metric to track. By combining the monitoring of user interactions (e.g., a conversation, as described in greater detail herein) with customer profiling data, it likewise provides immediate measurement of the effects of marketing, support, and public relation actions viewed at the enterprise, business unit, market segment, product, sub-brand and geographical levels. As a result, the trending of key performance indicators (KPIs) are supported, which provides more than a simple “pulse measurement” for a given point of time in the market. More specifically, social media interaction data is collected, and then processed in various embodiments to measure the affect of various social media user interactions while providing a vendor actionable data by gaining insight to the source and location of the interactions.

In various embodiments, an algorithm is implemented with the SNA system to integrate the contextual influence of user behavior within a social media environment with transactional data, such as purchase of a vendor's product, to generate near-real-time feedback to pro-active marketing responses. As a result, the SNA system provides vendors answers to question such as what was the initial reaction to the product prior to general availability, and how did social media user interactions change after the product was released? It will be appreciated that other marketing-related questions can be answered, such as how the initial marketing efforts were received, especially for an online demand generator (ODG), and who were the primary promoters that drove positive social media conversations and responses. Likewise, the question of what were influencers saying about a product or one of its features can not only be answered, but also with a metric showing the quantifiable affect of their user interactions. Those of skill in the art will recognize that statistically significant changes in net advocacy represent opportunities for changes in pricing, brand health change, and other aspects related to the health of a business.

In various embodiments of the invention, an SNA system 118 is implemented to monitor user interactions and generate proactive marketing responses within a social media environment. In these and other embodiments, a social media environment user 216 uses an information handling system 218 to log on to a social media environment, or site, enabled by a social media system 212, which is implemented on a social media server 210. As used herein, an information handling system 218 may comprise a personal computer, a laptop computer, or a tablet computer operable to exchange data between the social media environment user 216 and the social media server 210 over a connection to network 140. The information handling system 218 may also comprise a personal digital assistant (PDA), a mobile telephone, or any other suitable device operable to display a social media and vendor site user interface (UI) 220 and likewise operable to establish a connection with network 140. In various embodiments, the information handling system 218 is likewise operable to establish an on-line session over network 140 with the SNA system, which is implemented on an SNA server 202.

In this embodiment, SNA operations are performed by the SNA system 118 to monitor social media interactions related to a target subject, such as vendor's product. In one embodiment, the social media interactions are monitored and collected by a social media crawler operable to perform crawling operations in a target social media environment. The collected social media interactions are then stored in the SNA data repository 224. If it is determined that an increase in social media traffic related to the target subject is detected, then the social media traffic related to the target subject is processed to determine whether the subject traffic is positive or negative. If it is determined that the subject traffic is negative, then it is processed by the SNA system 118 to prioritize the most negative interactions. The source(s) (e.g., social media environment user 216) of the most negative interactions are identified and they are then displayed in an SNA system user interface (UI) 234 implemented on an SNA administratoristrator system 232. Once displayed, the sources are reviewed by an SNA system administrator 230 to determine the issues causing the negative interactions. Once the issues have been determined, proactive actions are performed by the SNA system administrator 230, or a designated SNA system agent, to address the identified issue(s). Thereafter, the primary source(s) of the subject traffic is contacted by the SNA system administrator 230, or a designated SNA system agent, to gain a better understanding of the issues causing the negative interactions. Additional proactive actions are then performed by the by the SNA system administrator 230, or a designated SNA system agent, while tracking the results of the proactive actions and the relationship with the primary source(s) of the subject traffic.

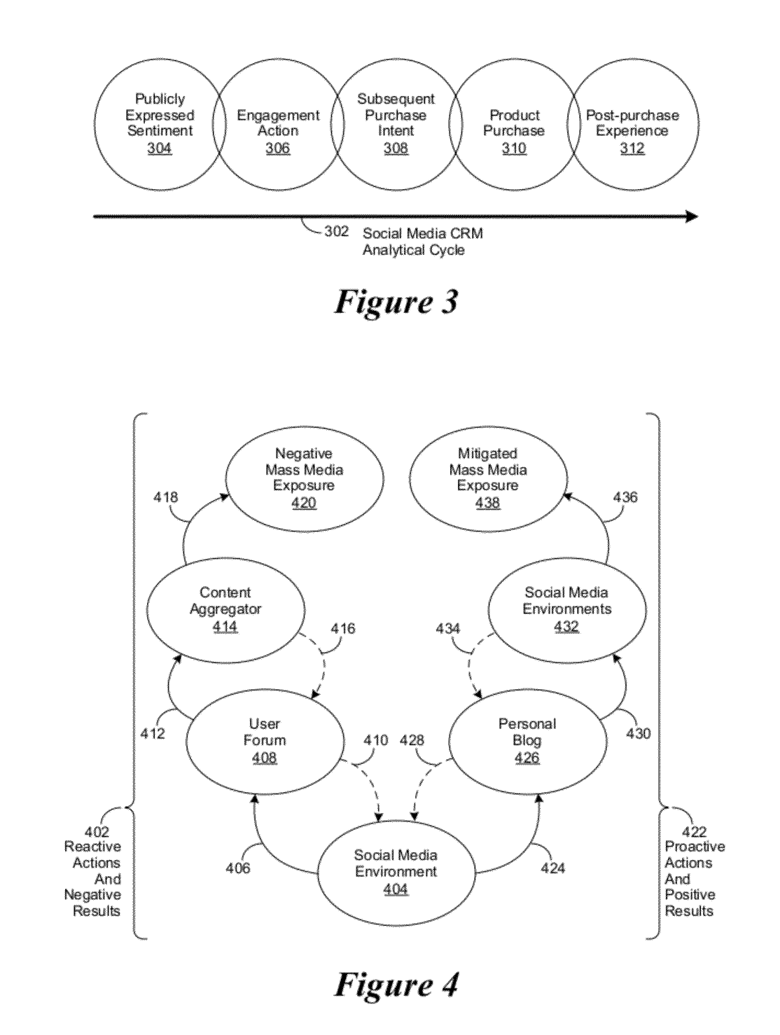

FIG. 3 is a simplified block diagram showing a social media customer relationship management (CRM) analytical cycle as implemented in accordance with an embodiment of the invention. In this embodiment, a social media CRM analytical cycle 302 comprises a publicly-expressed sentiment phase 304, an engagement action phase 306, a subsequent purchase intent 308 phase, a product purchase phase 310, and a post-purchase experience phase 312. As shown in FIG. 3, the associated action of a social media participant within each of the phases 306, 308, 310 and 312, from a CRM analysis standpoint, is dependent upon the affect of its predecessor phases.

As an example, a social media participant may read a highly-complimentary review of a product he or she may be considering purchasing during the publicly-expressed sentiment phase 304. As a result of that social media interaction, the social media participant may perform additional product research during the engagement action phase 306. Likewise, if additional product research is positive, such as user reviews of the product, then the social media participant may proceed to the vendor's web site in the subsequent purchase intent phase 308 to obtain additional information about the product. Assuming that the additional product information is appealing, and the social media participant has the means to execute a purchase, then he or she may purchase the product purchase phase 310. Likewise, once the product is received, and if the purchaser is happy with the product, then he or she may write a complimentary review for of the product during the post-purchase experience phase 312 for posting on a social media site.

From the foregoing, it will be apparent to those of skill in the art that a potential purchaser of a product may be either encouraged or dissuaded from purchasing the product based on pro or con sentiments about the product expressed by other members within a social media community. Accordingly, the ability to emphasize (e.g., “showcase”) positive comments, or mitigate the effects of negative comments, may have a direct and measurable affect on sales of a product.

FIG. 4 is a simplified block diagram showing the affect on social media feedback channels as a result of implementing a social networking advocacy (SNA) system in accordance with an embodiment of the invention. In this embodiment, one or more “conversations” are conducted between two or more users of a social media environment. As used herein, a “conversation” refers to an interaction within a social media environment between two or more users of the social media environment. As an example, a conversation may comprise a posting by an author of a blog, which in turn is read by one or more readers. As another example, a user may post a comment within a user forum, which in turn is read by one or more users, and in turn may or may not elicit a response from the one or more users. As yet another example, one user of a social media environment may ask a question of another user, which may or may not receive a response from the other user.

More specifically, a conversation is defined as a set of comments in a thread of user interactions within a social media environment. Each conversation has an author and a topic assigned to it, referenced to a predetermined ontology. In different embodiments, a conversation may originate from within a volume of user interactions, which in turn occur within one or more social media environments. Over time, the conversation may grow as additional users perform additional interactions, which are linked to the thread or related threads. In various embodiments, a conversation is defined as:

Conversation_j = { Author_j, Context_j, Thread_j, Relevance_j,
Date_j } _j
where:
Context_J = { (URL_j, Topic_j, Ontology_Node_j) }
Relevance_J = { (SearchEngine_rank_j, Campaign_j) }
Thread_j = { (Comment_ji, Author_ji)_ji }_i
Author_i = { UserID_i, CommunityID_i }
Comment_ji = { “Text”_ij, Date_ij }
CommunityID_i = { UserID_i, (DomainID_k, NetworkID_ik)_k }

where each networkID_ik has pairs of UserIDs and the weightage of the link is for the pair. It will be apparent to those of skill in the art that many such embodiments are possible and the foregoing is not intended to limit the spirit, scope, or intent of the invention.

In this embodiment, users of a social media environment 404 conduct conversations as described in greater detail herein. Without the implementation of an SNA system, reactive actions 402 are performed resulting in negative results, whereas with the implementation of an SNA system, proactive actions 422 are performed resulting in positive results. As an example, without the implementation of a SNA system, a user may post 406 a negative comment about a vendor's product in a user forum 408. In response, additional users may respond 410 with their own postings, either requesting additional details or perhaps adding negative comments of their own. Likewise, the negative comments may be collected 412 by a content collector 414 familiar to those of skill in the art. In turn, the collected negative comments, and their web address, may be referenced 416 by another posting by a user in the user forum 408. The collected negative comments may also be sourced 418 by various media agencies resulting in negative mass media exposure 420.

In contrast, with the implementation of an SNA system, a user may post 424 a negative comment about a vendor's product in a personal blog 426. In response, readers of the personal blog 426 may respond 428 with requests for additional details or perhaps adding negative comments of their own. However, since the personal blog 426 is monitored by an SNA system operated by the vendor, then such issues, questions, and negative comments are captured as they are posted and the vendor is notified so they can act proactively. As an example, a representative of the vendor may request additional information about the product issue with a promise to research a solution and provide it to the author of the personal blog. Likewise, the author of the personal blog may broadcast or otherwise provide 430 their posting, directly or indirectly, to one or more additional social media environments 432. In response, users of those additional social media environments 432 may respond 434 with their own questions, responses, or negative comments. However, since the additional social media environments 432 are likewise monitored by an SNA system operated by the vendor, the vendor can act proactively in a like manner as previously described. Through the monitoring and collection 436 of the negative responses, and the resulting proactive activities performed by the vendor, the possibility of negative mass media exposure is mitigated 438.

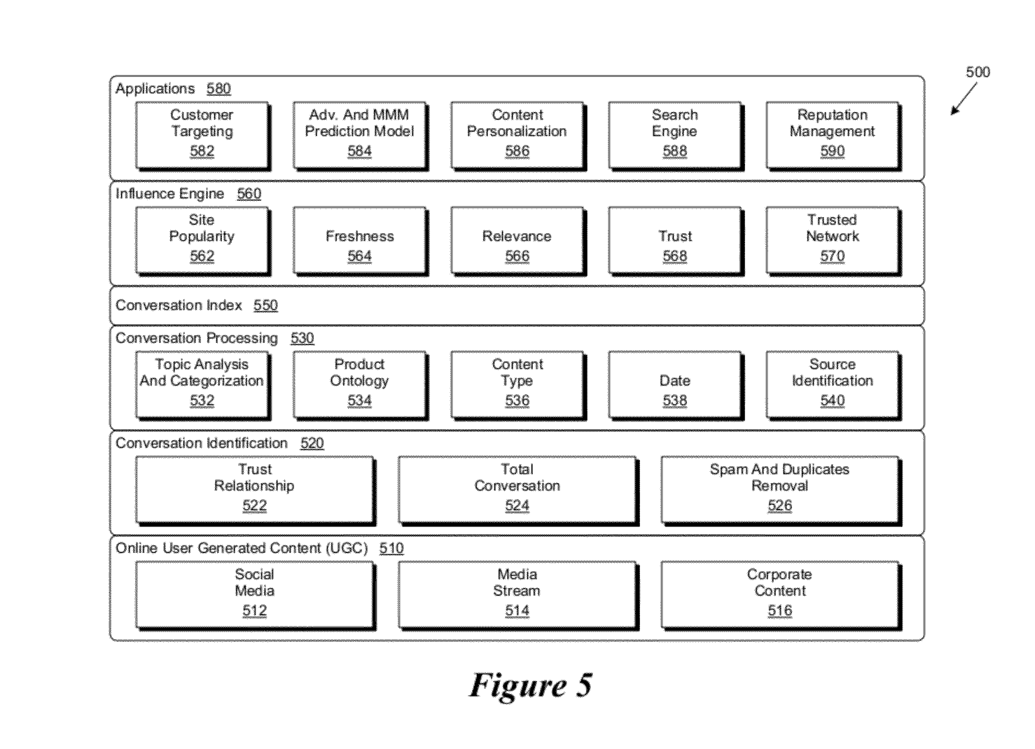

FIG. 5 is a simplified block diagram of the architecture of a social network advocacy (SNA) system as implemented in accordance with an embodiment of the invention. In this embodiment, the architecture of the SNA system 500 comprise online user-generated content 510, a conversation identification subsystem 520, a conversation processing subsystem 530, a conversation index 550, an influence engine 560, and applications 580. As shown in FIG. 5, the online user-generated content 510 comprises content that is generated by users of one or more social media 512 environments. The online user-generated content 510 likewise comprises content that is generated by media agencies and provided in a media stream 514, such as news feeds, and corporate content 516, such as content published by a vendor on their web site.

As likewise shown in FIG. 5, the conversation identification subsystem 520 comprises a trust relationship module 522, a total conversation module 524, and a spam and duplicates removal module 526. In this and other embodiments, the trust relationship module 522 identifies the parties involved in a given trust relationship and their respective influence as the source contributors to a conversation. Accordingly, the trust relationship module provides the interrelationship between conversation participants, and by extension, provides the basis for establishing mutual trust between users to assist in helping them accept recommendations from other users. The total conversation module 524 provides context to the data. The spam and duplicates removal module 526 is used to remove spam and duplicate conversations or elements of conversations.

The conversation processing subsystem 530 comprises a topic analysis and categorization module 532, a product ontology module 534, a content type module 536, a date module 532 to assign a date to a conversation, and a source identification module 540 for determining the source of a conversation. In one embodiment, the product ontology module 534 is implemented to manage the interrelationship of a vendor's products and their associated information. In another embodiment, the product ontology module 534 is implemented to manage the interrelationship of conversation topics and their corresponding categorizations, the content type and source of a conversation, and the date of the conversation as it relates to a vendor's product. In yet another embodiment, the product ontology module 534 is implemented manually. In still another embodiment, the product ontology module 534 is implemented automatically by the SNA system. In one embodiment the source identification module 540 identifies the author(s) of a conversation. In another embodiment, the source identification module 540 uses an “authority rating” as a factor to increase or decrease the relative influence rating of a conversation author. As an example, the managing editor of a trade publication may have a higher authority rating than a first-time poster to a technical help forum. As a result, the relative influence rating of the managing editor would be increased while the relative influence rating of the first-time poster would be decreased. The conversation index 550 is implemented in one embodiment to maintain an index of conversations and related information, such as the interrelationship information managed by the product ontology module 534.

As shown in FIG. 5, the influence engine subsystem 560 comprises a site popularity module 562 that determines the popularity of a social media environment or sub-environment, and a freshness module 564 that determines how recent a conversation took place. In one embodiment, the freshness module 564 determines the velocity, or how quickly, comments are added to a conversation by users of a social media environment. The influence engine subsystem 560 likewise comprises a relevance module 566 used to determine the relevance of a conversation to a vendor or their product(s) and a trust module 568 used to determine the trustworthiness of the source and content of the conversation. The influence engine subsystem 560 likewise comprises a trusted network module 570 used to capture the conversations as they are generated from known and relevant sources.

The applications subsystem 580, as shown in FIG. 5, comprises a customer targeting module 582 used to target one or more customer and an advertising and marketing mix modeling (MMM) prediction module 584. The applications subsystem 580 likewise comprises a content personalization module 586 for customizing content provided to a conversation, a search engine 588, and a reputation management module 590. In one embodiment, the reputation management module 590 is used to manage reputation data associated with a user of a social media environment. As used herein, reputation data refers to data associated with social commerce activities performed by a user of a social media environment.

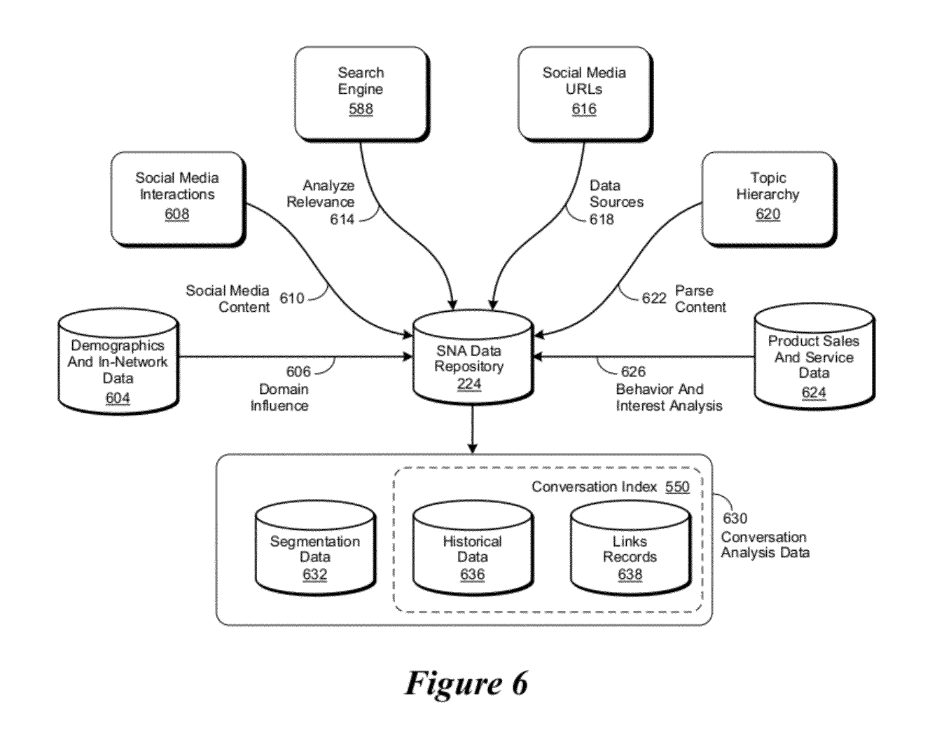

FIG. 6 is a simplified block diagram showing the aggregation and processing of social network advocacy (SNA) data in accordance with an embodiment of the invention to generate social media conversation analysis data. In this embodiment, an SNA data repository 224 comprises data provided by a demographics and in-network data repository 604, which is used to determine domain influence 606. As used herein, domain influence refers to the relevance of a domain as it relates to topics and concepts expressed in a conversation. The SNA data repository 224 likewise comprises data provided by a product sales and service data repository 624, which is used to perform behavior and interest analysis 626 of users of a social media environment. Likewise, the SNA data repository 224 receives data feeds resulting from social media interactions 608, which comprises social media content 610, and data feeds from a search engine 588, which are used for analyzing relevance 614 as it relates to SNA data. The SNA data repository 224 likewise receives social media Uniform Resource Locators (URLs) 616 as data feeds, which provide the location of the various data sources 618, and references a topic hierarchy 620, which is used to parse content 622.

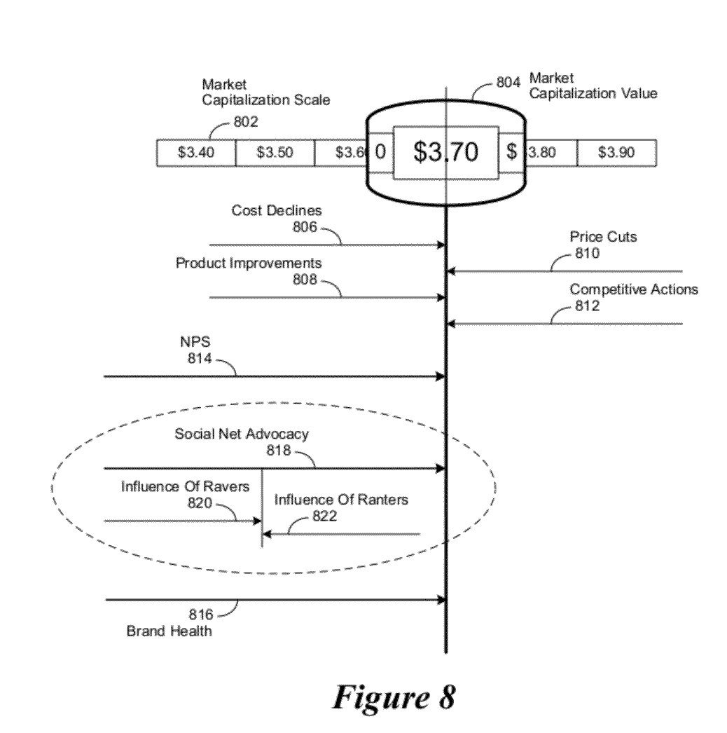

In this and other embodiments, data processing operations familiar to those of skill in the art are performed on data extracted from the SNA data repository 224 to generate conversation analysis data 630. As shown in FIG. 8, the conversation analysis data 630 comprises segmentation data 632 and a conversation index 550, which further comprises a repository of historical data 636 and a repository of links records 638. In one embodiment, the repository of segmentation data 632 is used to map users of a social media environment to a vendor's customers. In another embodiment, the repository of segmentation data 632 is used to further segment mapped users of a social media environment to various segments of a vendor's installed base or product lines. It will be apparent to skilled practitioners of the art that many such segmentation examples are possible and the foregoing is not intended to limit the spirit, scope or intent of the invention. In one embodiment, the repository of historical data 636 comprises historical conversations conducted in a social media environment, which are in turn cross-referenced to linking information, such as conversation thread identifiers, stored in the repository of links records 638.

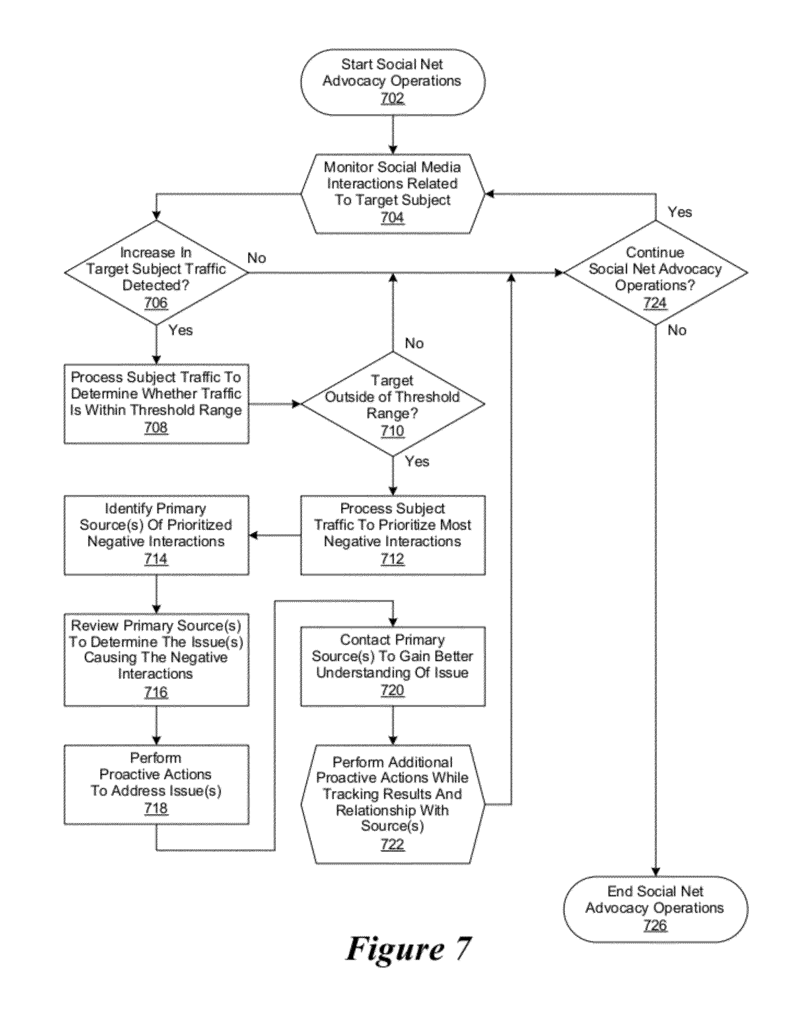

FIG. 7 is a generalized flow chart of the operation of a social network advocacy (SNA) system as implemented in accordance with an embodiment of the invention. In this embodiment, SNA operations are begun in step 702, followed by the monitoring of social media interactions related to a target subject in step 704. In one embodiment, the social media interactions are monitored and collected by a social media crawler operable to perform crawling operations in a target social media environment. A determination is then made in step 706 whether an increase in social media traffic related to the target subject is detected. If not, then a determination is made in step 724 whether to continue SNA operations. If so, then the process is continued, proceeding with step 704. Otherwise, SNA operations are ended in step 726.

However, if it is determined in step 706 that an increase in social media traffic related to the target subject is detected, then the social media traffic related to the target subject is processed to determine whether the subject traffic is positive or negative. A determination is then made in step 710 whether the subject traffic is negative. If not, then the process is continued, proceeding with step 724. Otherwise, the subject traffic is processed in step 712 to prioritize the most negative interactions. The source(s) of the most negative interactions are then identified in step 714 and they are then reviewed in step 716 to determine the issues causing the negative interactions. Once the issues have been determined, proactive actions are performed in step 718 to address the identified issue(s). Thereafter, the primary source(s) of the subject traffic is contacted in 720 to gain a better understanding of the issues causing the negative interactions. Additional proactive actions are then performed in step 722 while tracking the results of the proactive actions and the relationship with the primary source(s) of the subject traffic. The process is then continued, proceeding with a making a determination in step 724 whether to continue SNA operations. If so, then the process is continued, proceeding with step 704. Otherwise, SNA operations are ended in step 726.

FIG. 8 is a generalized depiction of the affect of an implementation of a social network advocacy (SNA) system on market capitalization value in accordance with an embodiment of the invention. As shown in FIG. 8, a market capitalization scale 802 comprising a plurality of per-share stock values further comprises a current market capitalization value 804 based on a current per-share stock price. It will be appreciated that the current market capitalization value 804 may be positively influenced by cost declines 806 or product improvements 808, such as new features, or negatively influenced by price cuts 810 or reactive competitive actions 812. It will likewise be appreciated that the changes in the current market capitalization value 804 may be correlated to changes in a vendor's, or a vendor's product's, Net Promoter Score (NPS) 814 and its Brand Health Score (BHS) 816. However, these correlations typically happen after the fact and are results-based. In contrast, the positive affect of social net advocacy 818 is realized from proactive efforts resulting from the implementation of a SNA system as described in greater detail herein. As shown in FIG. 8, the positive affect of social net advocacy 818 is increased by facilitating the influence of ravers 820 while mitigating the influence of ranters 822.

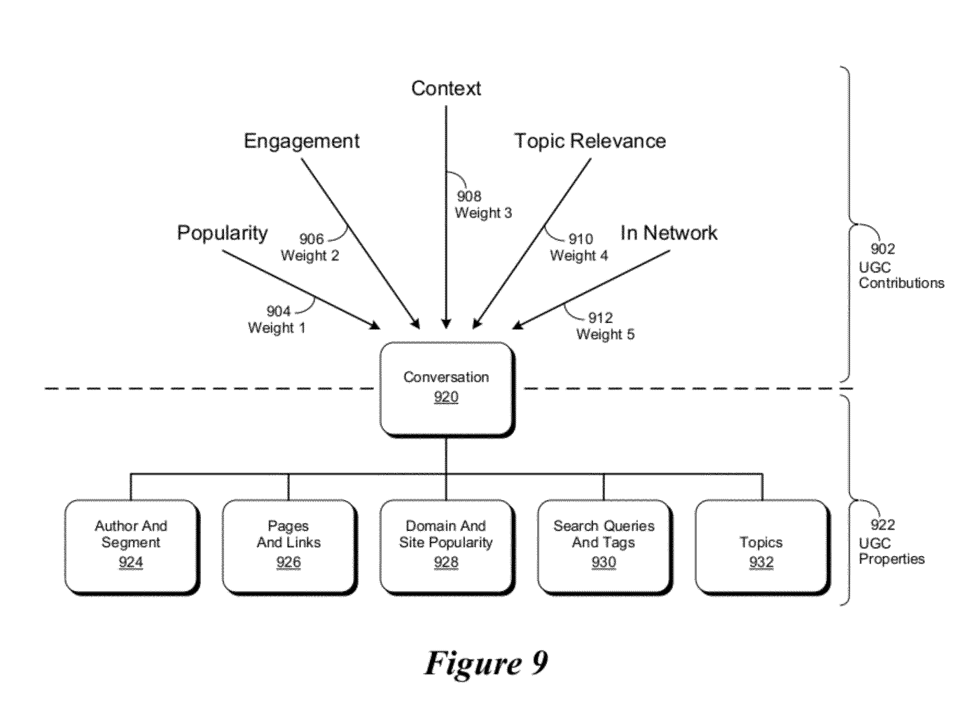

FIG. 9 is a simplified block diagram showing the use of a plurality of social media conversation parameters as implemented in accordance with an embodiment of the invention to dynamically generate a social net advocacy (SNA) metric. In various embodiments, a conversation 920, as described in greater detail herein, comprises a plurality of user-generated content (UGC) properties 922 and a plurality of UGC contributions 902. In this embodiment, the UGC properties 922 comprise conversation author and associated segment data 924, as described in greater detail herein, conversation page and link locations 926, and conversation domain names and their corresponding site popularity ratings 928. The UGC properties 922 likewise comprise conversation search query and tag data 930 and conversation topics data 932. The UGC contributions 902 likewise comprises plurality of parameters, such as ‘popularity’, ‘engagement’, ‘context’, ‘topic relevance’, and ‘in network’, which are respectively assigned a corresponding weighting factors ‘1’ 904, ‘2’ 906, ‘3’ 908, ‘4’ 910, and ‘5’ 912.

In various embodiments, the individual weighting of UGC contributions 902 may be adjusted in accordance with the respective values of the individual UGC properties 922 as input parameters of an algorithm implemented for generating an SNA metric. In these and other embodiments, the UGC properties 922 are likewise used as various parameters for an algorithm implemented for generating an SNA metric. Those of skill in the art will recognize that the individual weighting of UGC contributions 902, and their respective change in value, will affect the resulting value of the SNA metric generated by such an algorithm. Likewise, the resulting value of the SNA metric generated by such an algorithm may change if the weighting of individual UGC contributions 902 is changed as a result of corresponding changes in the values of individual UGC properties 922.

Accordingly, such changes in the values of individual UGC contributions 902 and individual UGC properties 922 will result in changes to the corresponding SNA metric associated with conversation 920. Furthermore, the value of the SNA metric will change dynamically as corresponding changes occur in the values of individual UGC contributions 902 and individual UGC properties 922. It will likewise be appreciated that the speed at which the value of the SNA metric changes will correspond to the speed at which corresponding changes occur in the values of individual UGC contributions 902 and individual UGC properties 922. Skilled practitioners of the art will likewise recognize that many such UGC contributions 902 and UGC properties 922 are possible for use as parameters, or variable values, for such an algorithm and that the foregoing is not intended to limit the spirit, scope or intent of the invention.

In various embodiments, a social media environment is modeled as relationships between various users and corresponding interactions, which in turn are associated with a conversation as described in greater detail herein. In these and other embodiments, users with similar profiles (e.g., social media usage patterns, interests, demographics, etc.) are grouped together to form a segment. In one embodiment, the reach, or the number of other users influenced by a target user of a social media environment is quantified by the target user's connection to a subset of the other users, and their respective responses to the user's social media interactions. In one embodiment, the influence of a target user is determined through the iterative implementation of the following algorithm, where at time t=0, the user influence UI of a user u₁, in a network of N users, is defined as:

UI(u₁,t=0)=1/N

At each time step:

$$UI ( ui , t + 1 ) = ( 1 - d ) / N + d {\sum }_{uj ∈ M ( ui )} \frac{UI ( {u}_{j} , t )}{L ( {u}_{j} )}$$

Where:

u₁, u₂ . . . uₙ are the users under consideration

M(uᵢ) is the set of users that interacted with uᵢ

L(uⱼ) is the number of outbound links of users uⱼ, and

N is the total number of users

In this embodiment, the quantitative influence of a target user is a dynamic metric that changes as the dynamics of the social media environment used by the target user evolves. As a result, the influence of the target user is periodically updated in a conversation index, which is described in greater detail herein.

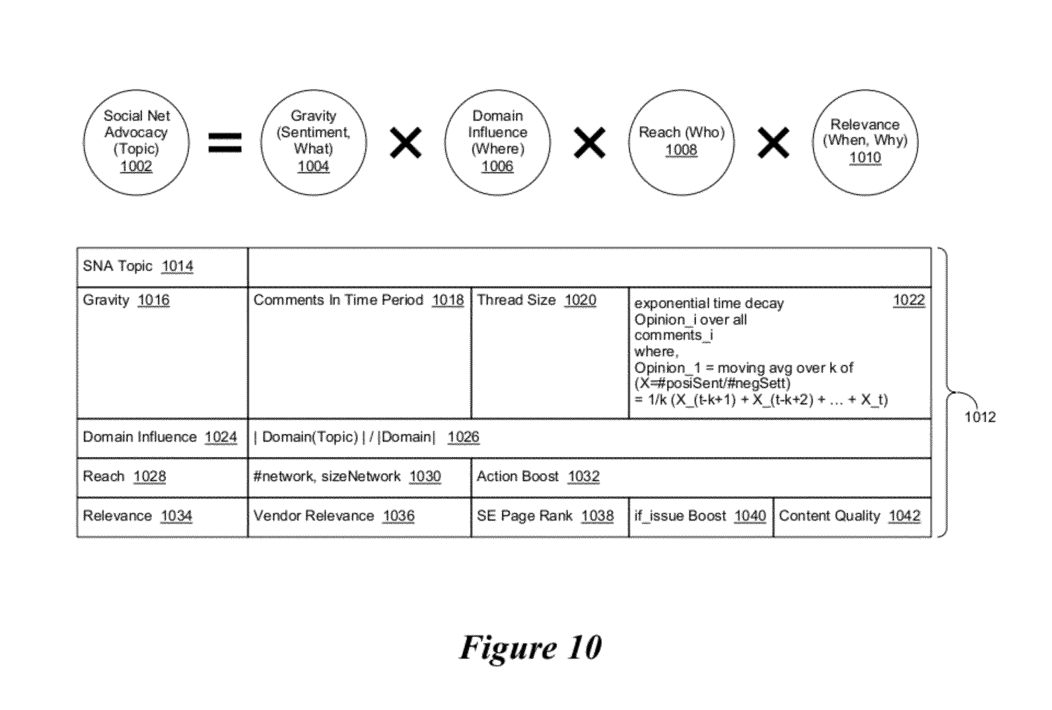

FIG. 10 is a simplified block diagram showing the generation of a social net advocacy (SNA) metric as implemented in accordance with an embodiment of the invention. In various embodiments, one or more algorithms are implemented to determine an SNA metric 1002. In this embodiment, the SNA metric 1002, which is associated with a target SNA topic or subject, is equal to the product of a conversation's gravity 1004, domain influence 1006, reach 1008, and relevance 1010. As shown in FIG. 10, a conversation's gravity 1004 refers to a sentiment (i.e., an opinion) expressed by a user in a social media interaction and what was expressed by that sentiment. As used herein, sentiment refers to negative or positive connotation expressed in a social media interaction. As an example, if a social media user proclaims that a vendor's product fails to perform as advertised, then a sentiment with negative connotation is expressed. Likewise, if a social media user proclaims that the performance of a vendor's product exceeded expectations, then a positive connotation is expressed. In various embodiments, gravity 1004 is measured by the size (e.g., the number of threads or elements) of a conversation, the volume of social media user interactions, and sentiment values as described in greater detail herein.

As likewise used herein, domain influence 1006 refers to the location where the conversation, or its contributing social media interactions, occurs. In various embodiments, the domain influence 1006 may be constrained to a single, or multiple, social media environments. Likewise, the domain influence 1006 may have different values dependent upon the corresponding characteristics of its associated social media environments. As an example, a conversation in a blog with a large audience may have a higher domain influence 1006 value than an individual posting in a user forum with a modest user base. Likewise, as used herein, reach 1008 refers to the number of users within one or more social media environments that are exposed to a conversation. As likewise used herein, relevance 1010 refers to the time, and reason, that the conversation occurs.

In this embodiment, the SNA metric 1002, which is associated with a target SNA topic 1014, is determined by the sum 1012 of the respective values of gravity 1016, domain influence 1024, reach 1028, and relevance 1034. As shown in FIG. 10, the value of gravity 1016 is determined as a product of the number of user interactions (e.g., comments) within a target social media environment in a predetermined time period 1018, the thread size 1020, and an exponential time decay 1022 value. Likewise, the value of domain influence 1024 is expressed as the quotient 1026 of the occurrence of a topic within a target domain divided by the occurrence of all topics within the target domain.

The reach 1028 is likewise determined as the product 1030, of the number of social media environments (e.g., networks), in relation to their corresponding size (e.g., number of users), and an action boost 1032. As used herein, an action boost 1032 is a proactive response, as described herein, performed within a target social media environment in relation to a target conversation. Likewise, the relevance 1034 is determined as the product of vendor relevance 1036, search engine (SE) page rank 1038, whether a conversation issue, as described in greater detail herein, result in a corresponding action boost 1040, and the quality 1042 of the content contained within the target conversation. In various embodiments, as described in greater detail herein, the weighting assigned to the respective values of the gravity 1016, domain influence 1024, reach 1028, and relevance 1034 may vary, resulting in a corresponding variation in the value for the SNA metric 1002.

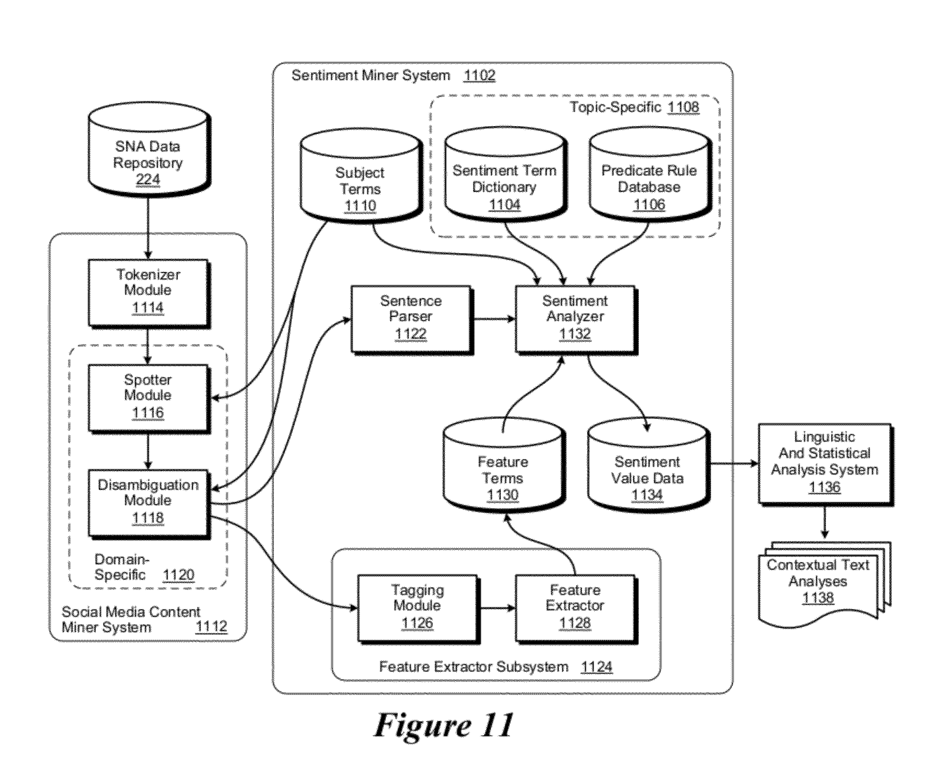

FIG. 11 is a simplified block diagram showing the operation of a sentiment miner system as implemented in accordance with an embodiment of the invention to generate social media contextual text analyses. In various embodiments, social network advocacy (SNA) data provided by an SNA data repository 244 is processed by a social media content miner system 1112 in conjunction with a sentiment miner system 1102 to provide input to a linguistic and statistical analysis system 1136 for the generation of contextual text analyses 1138. In this embodiment, the plurality of social media content miners 112 comprises a tokenizer module 1114 and domain-specific 1120 spotter 1116 and disambiguation 1118 modules. The sentiment miner system 1102 comprises a repository of subject terms 1110, feature terms 1130, and sentiments 1134. The sentiment miner system likewise comprises a sentiment term dictionary 1104 and a predicate rule database 1106, which are topic-specific 1108.

As shown in FIG. 11, SNA data is received by the tokenizer module 1114 from the repository of SNA data 224. Once it is received, tokenizer operations familiar to those of skill in the art are performed and the resulting output is provided to the spotter module 116, which uses subject term data provided by the repository of subject terms 1110 to perform subject term spotting operations. The resulting spotted subject terms are in turn provided to the disambiguation module 1118, which likewise uses subject term data provided by the repository of subject terms 1110 to perform subject term disambiguation operations.

Once the subject term disambiguation operations are completed, the resulting disambiguated terms are provided by the disambiguation module 1118 to the sentence parser module 1122 and to the tagging module 1126 of the feature extractor subsystem 1124. The sentence parser module 1122 then parses the disambiguated terms out of their corresponding sentences and provides them to the sentiment analyzer 1132. Concurrently, the tagging module 1126 performs tagging operations familiar to those of skill in the art on the disambiguated terms. The resulting tagged terms are then provided to the feature extractor module 1128, which extracts the tagged terms and stores them in the repository of feature terms 1130.

Thereafter, the sentiment analyzer module 1132 uses predetermined data respectively provided by the repositories of subject terms 1110 and sentiments 1134, along with data provided by the sentiment term dictionary 1104 and predicate rule database 1106, to analyze the disambiguated terms for their associated sentiment values. The resulting sentiment value data, as described in greater detail herein, is then stored in the repository of sentiment value data 1134. In turn, the sentiment value data is provided by the repository of sentiment value data 1134 to the linguistic and statistical analysis system 1136, which uses it to generate contextual text analyses 1138 as described in greater detail herein.

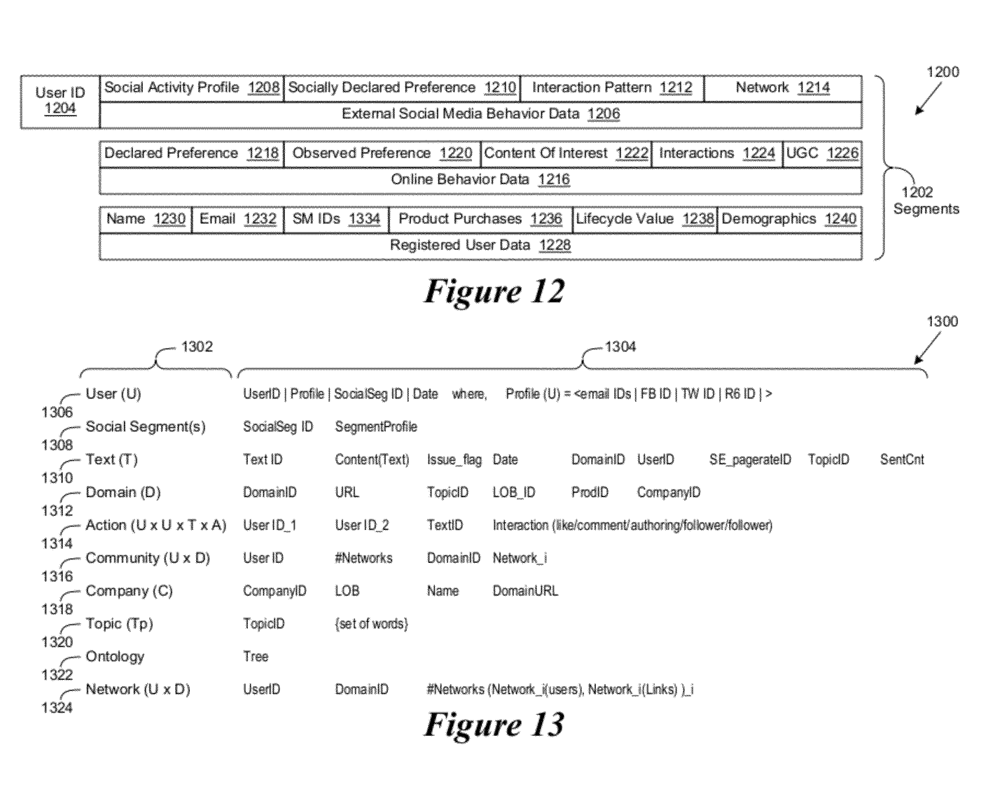

FIG. 12 is a generalized depiction of a social network advocacy (SNA) conversation segmentation (i.e., a user profile relating to behavior, transactional and social activity for social segmentation) table as implemented in accordance with an embodiment of the invention. In this embodiment, a conversation segmentation table 1200 (i.e., a table containing customer profiles for social segmentation) comprises a plurality of segments 1202, further comprising a User ID 1204, external social media behavior data 1206, online behavior data 1216, and registered user data 1216. The external social media behavior data 1206 further comprises a social activity profile 1208, a socially declared preference 1210, an interaction pattern 1212 and an associated social media environment, such as a social media network 1214. Likewise, the online behavior data 1216 comprises a declared behavior preference 1218, an observed behavior preference 1220, content of interest 1222, a plurality of social media interactions 1224, and associated user generated content (UGC) 1226. The registered user data 1228 likewise comprises a user's name 1230, email address 1232, associated social media identifiers (IDs) 1234, product purchases 1236, their associated lifecycle value 1238, and associated user demographics 1240.

FIG. 13 is a generalized depiction of a social network advocacy (SNA) conversation index table as implemented in accordance with an embodiment of the invention. In this embodiment, indexing operations are performed by an SNA system on the conversation segmentation table 1200 shown in FIG. 12 to generate an SNA conversation index table 1300. As shown in FIG. 13, the resulting SNA conversation index table 1300 comprises a plurality of index elements 1302, each of which has one or more corresponding index sub-elements 1304. As likewise shown in FIG. 13, the plurality of index elements 1302 comprises ‘User’ 1306, ‘Social Segment(s)’ 1308, ‘Text’ 1310, ‘Domain’ 1312, ‘Action’ 1314, ‘Community’ 1316, ‘Company’ 1318, ‘Topic’ 1320, ‘Ontology’ 1322, and ‘Network’ 1324 elements.

In this embodiment, the ‘User’ 1306 element comprises UserID, Profile, Social Segment ID, and Date sub-elements, where Profile(User)=<email IDs|social media ‘A’ ID|social media ‘B’ ID through social media ‘n’ ID|>. Likewise, the ‘Social Segment(s)’ 1308 segment comprises ‘SocialSegID’ and ‘SegmentProfile’ sub-elements, and the ‘Text’ 1310 element comprises ‘TextID’, ‘Content(Text)’, ‘Issue_Flag’, ‘Date’, ‘DomainID’, ‘UserID’, ‘SE_pagerateID’, ‘TopicID’, and ‘SentCnt’ sub-elements. The ‘Domain’ 1312 element likewise comprises ‘DomainID’, ‘URL’, ‘TopicID’, ‘LOB_ID’, ‘ProdID’, and ‘CompanyID’ sub-elements, while ‘Action’ 1314 element is defined as the product of a plurality of ‘User’ 1306 elements and the ‘Text’ 1310 and ‘Action’ 1314 elements. Accordingly, the ‘Action’ 1314 element comprises a plurality of ‘UserIDs’, ‘TextID’, and ‘Interaction’ sub-elements.

Likewise, the ‘Community’ 1316 element is defined as the product of the ‘User’ 1306 and ‘Domain’ 1312 elements and comprises ‘UserID’, ‘#Networks’, ‘DomainID’, and ‘Network_i’ sub-elements. The ‘Company’ 1318 element likewise comprises ‘CompanyID’, ‘LOB’, ‘Name’, and ‘DomainURL’ sub-elements, while the ‘Topic’ element comprises ‘TopicID’ and ‘set of words’ sub-elements. Likewise, the ‘Ontology’ 1322 element comprises a ‘Tree’ sub-element, and the ‘Network’ 1324 element, which is defined as the sum of the ‘User’ 1306 and ‘Domain’ 1312 elements, comprises ‘UserId’, ‘DomainId’, and ‘#Networks(Network_i(users), Network_i(Links))_i’ sub-elements.

In this embodiment, the conversation index 1300 is updated dynamically as its corresponding conversation grows in size or changes in its composition. For instance, the influence of the conversation, as described in greater detail herein, will change as its corresponding size rises above a predetermined threshold value. Likewise, a conversation more closely related to a predetermined issue will have more impact.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for monitoring user interactions and generating proactive responses thereto within a social media environment comprising:
performing conversation monitoring operations within a social media environment to detect an individual conversation of a plurality of conversations comprising a target subject;
collecting conversation data elements associated with the individual conversation;
processing the conversation data elements to generate a contextual text analysis of the conversation data elements; and
processing the contextual text analysis to generate a social network advocacy metric associated with the individual conversation.

2. The method of claim 1, wherein the conversation data elements are further processed to generate social network advocacy data.

3. The method of claim 2, wherein data associated with the contextual text analysis is processed with the social network advocacy data to generate conversation segment data.

4. The method of claim 3, wherein the conversation segment data is further processed with the social network advocacy data to generate a social network advocacy conversation index table.

5. The method of claim 4, wherein data associated with the social network advocacy conversation index table is used to generate a social network advocacy metric.

6. The method of claim 5, wherein the value of the social network advocacy metric changes as the size of the individual conversation rises above a predetermined threshold value.

7. A system comprising:
a processor;
a data bus coupled to the processor; and
a computer-usable medium embodying computer program code, the computer-usable medium being coupled to the data bus, the computer program code interacting with a plurality of computer operations and comprising instructions executable by the processor and configured for:
performing conversation monitoring operations within a social media environment to detect an individual conversation of a plurality of conversations comprising a target subject;
collecting conversation data elements associated with the individual conversation;
processing the conversation data elements to generate a contextual text analysis of the conversation data elements; and
processing the contextual text analysis to generate a social network advocacy metric associated with the individual conversation.

8. The system of claim 7, wherein the conversation data elements are further processed to generate social network advocacy data.

9. The system of claim 8, wherein data associated with the contextual text analysis is processed with the social network advocacy data to generate conversation segment data.

10. The system of claim 9, wherein the conversation segment data is further processed with the social network advocacy data to generate a social network advocacy conversation index table.

11. The system of claim 10, wherein data associated with the social network advocacy conversation index table is used to generate a social network advocacy metric.

12. The system of claim 11, wherein the value of the social network advocacy metric changes as the size of the individual conversation rises above a predetermined threshold value.

13. A computer-usable medium embodying computer program code, the computer program code comprising computer executable instructions configured for:
performing conversation monitoring operations within a social media environment to detect an individual conversation of a plurality of conversations comprising a target subject;
collecting conversation data elements associated with the individual conversation;
processing the conversation data elements to generate a contextual text analysis of the conversation data elements; and
processing the contextual text analysis to generate a social network advocacy metric associated with the individual conversation.

14. The computer usable medium of claim 13, wherein the conversation data elements are further processed to generate social network advocacy data.

15. The computer usable medium of claim 14, wherein data associated with the contextual text analysis is processed with the social network advocacy data to generate conversation segment data.

16. The computer usable medium of claim 15, wherein the conversation segment data is further processed with the social network advocacy data to generate a social network advocacy conversation index table.

17. The computer usable medium of claim 16, wherein data associated with the social network advocacy conversation index table is used to generate a social network advocacy metric.

18. The computer usable medium of claim 17, wherein the value of the social network advocacy metric changes as the size of the individual conversation rises above a predetermined threshold value.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
